(19) United States
(12) Patent Application Publication
(10) Pub. No.: US 2013/0041680 A1
(43) Pub. Date: Feb. 14, 2013

(54) AUTOMATED SYSTEM FOR SELECTING AND ALLOCATING STORED ALLOGENEIC BIOLOGICAL CELLS FOR TRANSPLANTATION, THERAPY AND RESEARCH

(71) Applicant: Thomas Klein, Potsdam (DE)

(72) Inventor: Thomas Klein, Potsdam (DE)

(73) Assignee: CYTOLON AG, Berlin (DE)

(21) Appl. No.: 13/576,886

(22) PCT Filed: Feb. 7, 2011
(86) PCT No.: PCT/EP2011/000615

§ 371 Date: Oct. 31, 2012

Related U.S. Application Data
(60) Provisional application No. 61/301,702, filed on Feb. 5, 2010.

(30) Foreign Application Priority Data
Feb. 5, 2010 (EP) 10075053.8

(51) Int. Cl. G06Q 50/22

(52) U.S. Cl. 705/2

(57) ABSTRACT

The invention relates to a system for the automatic, fast and dynamic mediation of biological cells for transplantation, therapy or research purposes for registers of patients having differing indications between extraction centers or banks (deposits) and clinics, transplantation centers or research institutions, service providers (diagnosis, further processing of the preparations and logistics) and the monitoring and support of the processes of requirements transmission, integration from diagnostics technologies and techniques, to further processing, to delivery and payment of a cell preparation suited for allogeneic transplantation or other biological preparation, to the use of the mediated preparation to tracking of the results in patients and to the provision of said data for statistical and other purposes. The system according to the invention is for the first time able to suggest, online and automatically, complete solution proposals for specific stored transplantations for individual patients in extensive registers of patients and to consider prioritized deposits and to create medicinally and logistically advantageous solution proposals when ordering a plurality of preparations. The system is furthermore for the first time able to automatically integrate and coordinate service providers incorporated in the process, such as logistics companies and further processors of the required preparations, into to the process and can conduct all processes and financial transactions as a central tool (platform).

The invention relates to a system for the automated, rapid, and dynamic allocation of biological cells for transplantation, therapy, or research purposes between collection centers or banks (deposit sites) and clinics, transplant centers, or research institutions, as well as to monitoring and supporting the processes from the time of diagnosis to the transmission of the request, throughout further processing and delivery to the time of payment for one or more cell preparations suited for allogeneic transplantation, from the application of the allocated preparations to tracking the results in the patient and to providing these data for statistical and other purposes. For the first time, the system is able to propose, online and automatically, complete solutions regarding specifically stored transplants for extensive patient registers, thereby taking into account prioritized deposit sites and creating medically as well as logistically advantageous proposed solutions in the ordering of multiple preparations. Moreover, the system is able for the first time to automatically select involved service providers such as diagnostic service providers, logistics companies, and processers of the required preparations, and integrate them into the process and coordinate them.

Various procedures and methods of allocating umbilical cord blood (UCB) preparations between collection centers and umbilical cord blood banks on the one hand and clinics and transplant centers on the other hand have emerged in recent years. All of these procedures and methods have their origin in processes required in the allocation of bone marrow. However, no automated processes are available as yet. A clinic in need of a UCB preparation intended for a patient/recipient for transplantation would make inquiries with registers as to whether they have a UCB preparation available for their patient that correspondingly complies with a number of biological and medical characteristics. The registered data relate to the so-called HLA match or to the number of cells present in the preparation, or other medical or biological data (blood group, for example).

Clinics and transplant centers have so-called coordinators who perform the selection of a particular UCB transplant with reference to the submitted data. The coordinators suggest a selection of preparations to the attending physician. The physician decides which, if any, transplant will be used. For each preparation, the clinic is required to inquire about all important data relating to the respective preparation in order to be able to order the proper umbilical cord blood unit. However, no worldwide standards have been defined for information deposited in a so-called unit report. Also, no correlation between data of individual preparations has been made as yet. When selecting preparations, coordinators are subject to an iterative process which is time-consuming and prone to error.

This problem is aggravated by the fact that many deposited UCB preparations, although suitable according to the HLA match, for example, are too small for transplantation; i.e., the number of cells in the preparation is insufficient. Clinical research during the past five years has demonstrated that the number of nucleated cells (TC) and cells hereinafter referred to as CD34+ cells (having the capability of hematopoiesis) included in umbilical cord blood is of crucial importance for successful transplantation. With a large number of cells, the genetic fit (HLA match) may be substantially less compared to the HLA match required in bone marrow transplantations. While the required numbers of cells and their correlation with the HLA match have been described in the prior art, they have not been systematically used in established methods as yet. At present, coordinators and umbilical cord blood banks are confronted with the problem of identifying matching preparations in individual tests and comparing them with the patient data. This is all the more difficult because possible preparations are usually distributed over a number of banks and have been described using different methods and standards.

These problems will become more acute in the future due to the possibility of using multiple preparations, so-called multi-cord preparations, in a single patient. Moreover, the current development allows for the successful treatment of additional diseases such as, for example, dilative cardiomyopathy (hereafter “DCM”) and diabetes mellitus, using multi-cord preparations, so that the number of potential patients awaiting treatment increases by several orders of magnitude, and patient data registers of increasing size must be administered.

Aside from the problems with finding suitable preparations, there exists the challenge of coordinating diagnostic service providers and logistics service providers and the integration of processers, in particular for the simultaneous use of multiple preparations. The time-critical coordination of transplant centers, diagnostic and logistics service providers, processers, and storage sites represents a complex challenge in this environment. The prior art does not offer an adequate solution for this problem.

As disclosed in the prior art, for example in US 2002/0132343 A1, successful treatment of (leukemia, etc.) patients with matching umbilical cord blood preparations requires a high number of cells and high/guaranteed product quality (including certification by the FDA, etc.) which may be provided in addition to simple and direct use in a transplant clinic. An integrated system (SCBS) for expanded and matched stem cells (not only umbilical cord blood) is described which comprises the entire life and production cycles (obtaining source material, production, certified quality assurance, and delivery). The integrated system meets the regulatory quality requirements and standards in accordance with the FDA, etc., such as FACT, CGTP, and AAB, and a preparation matching the patient's tissue is selected from an existing (allogeneic) umbilical cord blood reservoir. US 2002/0132343 A1 describes that well-known methods for typing (HLA typing of at least six loci) donor and patient cells in compliance with the regulatory standards are to be used. In addition, the use of an automated tracking system for monitoring individual preparations/samples and follow-up is described therein. The donor cells (source material) come from a certified source (umbilical cord blood bank) where the relevant information (TNC, HLA loci, number of CD34+ cells, for example) per sample is collected in accordance with the quality standards. According to US 2002/0132343 A1, the source material is processed in such a way that only relevant cells are processed, and the desired cells (CD34+ cells, for example) are expanded ex vivo. The stem cell products thus produced are provided for use in the form of a patient treatment kit. They include a defined characteristic and may be used directly by the attending physician. An ordered SCBS product matches at least 4/6 antigens or 3/6 alleles with 2×10⁷ cells/kg for children (<12 years) or patients of <50 kg body weight and 1×10⁷ cells/kg body weight for all other patients. As a central element, US 2002/0132343 A1 describes the ability of direct delivery of SCBS products to transplant centers having ordered the product. To this end, the SCBS products are packed in special containers to be shipped by courier services, while maintaining the quality standards. The SCBS system and the methods described therein do not consider the problems of automated selection of suitable preparations. What is described is the current state of the art of manually selecting stem cell preparations (HLA matching, cell count/weight correlation, etc.). US 2002/0132343 A1 does not show how the time needed to identify a suitable donor material can be reduced, or how the manual steps required to select between a number of potentially suitable preparations can be automated.

Furthermore, US 2002/0168639 A1 discloses that, as a result of the limited capacity of the analytical instruments, it is difficult to compare a tissue sample with a large number of comparative samples. US 2002/0168639 A1 describes a profiled substrate which, on the one hand, may receive a sample tissue thereon and, on the other hand, a microarray allowing the use of various comparative samples for simultaneous analysis. The reactivities of test tissue or microarray samples are stored in a database and correlated with other information about the patient from whom the test tissue has been obtained (for example, age, weight, gender, medical history). The database system disclosed in US 2002/0168639 A1 is connected to an information management system (IMS) capable of performing searches and correlations. This allows comparisons and correlations of biological reactivities between test tissue and samples of the microarray. To this end, the capabilities of state-of-the-art business analytics products for data analysis and visualization, as in “Tibco Spotf ire,” are utilized. US 2002/0168639 A1 involves obtaining and storing data relating to tissue cells and the donors thereof. These data are compared using standard methods of analysis so as to identify correlations, etc. for research or diagnostic purposes. There is no disclosure indicating how to perform a correlation directed to a specific issue. Rather, reference is made to general options reflecting the prior art.

GB 2407193 A describes a system allowing automated performance and evaluation of biological cell line experiments, including image analyses. On the one hand, the system comprises a unit that allows new experiments to be defined and carried out in an automated manner, the system being open in terms of the ability for any experiment and device to be registered and used in a modular form. The second system component comprises the automated analysis (image analysis) of experiments, the primary aspect mentioned being image analysis of assays; i.e., the results of the assays (the experiments) are fed into the system and analyzed by same. It is possible to use variable/extendable analytical techniques. The overall system automatically controls the implementation and analysis of multiple successive experiments. The implementation process may be flexibly defined or adapted for this purpose. The results are stored in a database and displayed to the user via flexibly definable reports. GB 2407193 A discloses that complete laboratory processes may be automated for cell line experiments. Similar situations are known from industrial practice in many domains of application. GB 2407193 A provides a framework for automated data analysis as part of the process.

US 2004/0121369 A1 addresses the problem of automating the flexible use of a plurality of devices and analytical methods as part of complex biological laboratory experiments. Successively passing data for assessment through various software applications or parallel processing of data as part of changing laboratory processes is a complex matter, and requires individual human coordination (manual data formatting or complex individual programming). US 2004/0121369 A1 provides a flexible framework for automating laboratory experiments and evaluating same. The system allows flexible registration (connection) of laboratory equipment controls to be used as part of individually and freely definable experimental operations. Likewise, analytical equipment and software can be flexibly registered and integrated into the overall process. US 2004/0121369 A1 describes a flexible registration mechanism for this purpose, which solves the problem of different interfaces and protocols of devices and analytical applications, so that efficient coupling thereof is possible. The information is stored in a database. US 2004/0121369 A1 addresses the problem of increasing the efficiency in specific processes. As demonstrated therein, working on a problem that previously required manual support by skilled personnel may proceed in an entirely automated fashion. However, the solution to the problem resides in efficient coupling of devices rather than efficient selection of specific cell preparations.

WO 02/077640 A2 discloses a system intended to efficiently process and evaluate large amounts of data which arise in connection with the analysis of biomolecules using microarrays and, at the same time, to optimize the analytical process. The disclosed automated system allows grouping, for example on the basis of physical properties, of large amounts of data in a database using data mining methods, and analyzing the results by a self-learning neural network. By use of mathematical and statistical methods, the neural network allows automated generation of new samples which meet the requirements of a desired task. Thus, mathematical and statistical (self-learning) algorithms are used to respond to specific problems with respect to a sought biomolecule. However, the algorithms are not transferable to other systems, and may only be used in the above-mentioned system.

US 2008/0014174 A1 describes the methodical production of lymphocyte preparations, the storage thereof, as well as a ready-to-use kit for application in a patient. The lymphocytes are derived from peripheral blood of donors matching with the patient in at least four loci. Certain tumors, viral infections, and autoimmune diseases are intended to be treated using HLA-matched allogeneic activated lymphocytes. There are no statements relating to the selection process in detail.

Furthermore, DE 600 30 978 T2 discloses a method which allows simultaneous quantitative high-quality analysis of a plurality of biological samples, using a sensor platform. In particular, the chemical and physical properties of a sample to be analyzed are determined by the sensor platform and introduced into a signal assessment. The system can be used, among other things, to determine the HLA values of samples.

There is no description in the prior art relating to the exact process of selecting the preparations. It is generally known which parameters should be used at minimum to select suitable preparations, but it is not possible to deduce the “best” preparation from the analyzed preparations.

Furthermore, there is no description in the prior art relating to a selection system which selects a suitable preparation and presents the result to the coordinator accordingly, and which can optionally proceed in an automated fashion. The prior art discloses that the selection of suitable preparations is primarily made on the basis of HLA typing, and provides essentially no further criteria. In this regard, in particular the prior art does not describe how automated preferred storage sites or medically or logistically advantageous solutions for multiple preparations are favored in the selection. Moreover, there are no projections as to time and cost, nor is there any statement regarding the probability of success on the basis of determined empirical values. Furthermore, there is no description in the prior art relating to a selection system which selects a suitable preparation and accordingly presents the result to the coordinator or requester. The prior art also does not describe, for fairly large patient registers, how to automatically make a comparison with the preparation inventory or to automatically update same; rather, there are only consistent references to the manual search for an individual patient.

Also, the prior art does not disclose any solutions to multiple transplantations. This is a solution strategy used in the event that no suitably large preparation can be found, and it is necessary to transplant multiple preparations. In the prior art, the search problem is extended to two or more preparations which together include sufficient cells and also have sufficiently matching HLA values with respect to one another and also to the patient. The prior art also fails to address the problem of integrating diagnostic and logistics service providers and preparation processers as a result of the multiple transplantation and/or new treatable diseases.

The object of the invention is therefore to provide a system that does not have the disadvantages of the prior art and allows the automatic selection, processing, and distribution of one or more suitable preparations, in particular UCB preparations.

Surprisingly, the object is achieved by the independent claims. Preferred embodiments of the invention may be inferred from the subclaims.

Quite surprisingly, a system for allocating and selecting biological cells or tissues, in particular umbilical cord blood preparations, for transplantations, therapies, and/or research purposes between at least one collection center and/or storage site and at least one clinic, transplant center, and/or research facility may be provided, the latter communicating with one another via wired and/or wireless connections on one or more processing units, especially computers, medical systems, storage devices, and/or special processors, and being connected via a network composed of the multiple processing units by means of which data are exchanged, wherein the system comprises the following steps:
Inputting data of umbilical cord blood preparations in a computer and storing on a storage medium. The data of the UCB preparations are input into the system via a template, the system appropriately storing the data on a storage device, and these data being readable by means of the processing units that are connected via the network,
Presetting the search criteria with the option of favoring preferred storage sites, in particular the storage of the search criteria on a storage medium and/or a processing unit. A coordinator, i.e., a person, for example on behalf of a transplant center, who is searching for a preparation that matches a recipient, enters via the search interface the values and data for a recipient which a matching preparation must meet, in order to obtain a “match,” i.e., a correspondence or “hit,”
Patient search of individual, fairly large registers of patients with various indications, including acute myeloid leukemia (AML), dilated cardiomyopathy (DCM), diabetes mellitus, and/or ischemic stroke, and
Order processing and tracking, including the integration of service providers comprising diagnostics service providers, logistics service providers, and/or processers, the system carrying out financial transactions, and
   in particular, the potential umbilical cord blood preparations are arranged and selected according to priority of the bank, medical and logistical factors including time and cost projections, the probability of therapeutic success, HLA match, patient weight, number of nucleated cells (TNC), number of hematopoietic cells (CD34+), and number of CD133+ cells.

Using this system, a coordinator of a transplant center searching, for example, for a matching UCB preparation for a recipient is able to access the preparations that are available in a UCB bank, thus quickly and easily identifying preparations which match the recipient. In this regard, a patient search is carried out for individual, fairly large registers of patients with indications including acute myeloid leukemia (AML), dilative cardiomyopathy (DCM), diabetes mellitus, or ischemic stroke.

The priority or preference for a bank (storage site) is understood to mean, on the one hand, a ranking of all banks by evaluations of all clients of this bank, which may be made using the platform, in particular the system. On the other hand, the user himself may specify a priority for banks by arranging the banks in a sequential order, thus generating his own personal ranking system. These orderings may be subsequently used when searching for a preparation.

Within the meaning of the invention, a system describes a set of individual components which are related to one another and interact. Advantageously, a system may comprise programs and data processing equipment as well as physical elements such as transport containers and UCB preparations,

Within the meaning of the invention, processing units preferably describe input devices by means of which data or information is entered and stored, preferably in digital form. The processing units preferably comprise computers, medical systems, storage devices, and/or special processors suitable for input and storage. In a preferred embodiment the processing units may be present separately and/or in various forms of hardware, software, and/or firmware. Thus, it may be advantageous if medical systems, such as analyzers, automatically transfer the analyzed data into the system and require no manual input to this end.

The teaching of the invention also represents a combination invention in which the above-mentioned elements cooperate to achieve an overall successful technical outcome, resulting in a synergistic effect which is manifested in the surprising properties of the system. The system according to the invention compares the patient data of the administered patient registers with the data of registered cell preparations, using a multi-level compatibility matrix and varying classification criteria. Advantageously, comparison is fully automatic, and an attending physician can advantageously gain online access to the data. A physician may advantageously be automatically provided with proposed solutions as to which single preparation (single transplant) or which intermatching preparations (multi-transplant) are possible for transplantation. In this way, it is possible to fundamentally change and substantially improve the actual advantage of ready-to-use stored UCB preparations compared to lengthy comparative searches performed by coordinators. The system is suitable for all biological, biochemical, or chemical materials subject to time-critical allocation in transplantations or other (medical) applications.

The automated system is also able to select and allocate chemical and biological therapeutic substances, and to integrate molecular or genetic analyses and diagnoses in the selection and definition of possible therapeutic approaches.

In one preferred embodiment, the invention further relates to a system for allocating and selecting biological, biochemical, or chemical substances on a computer system consequent to a command issued by a subject, the computer system comprising processing units, in particular computers, medical systems, storage devices, and/or special processors by means of which data are exchanged, which are connected to one another via wired and/or wireless connections, characterized by:
a) Inputting parameters of at least one patient, UCB donor, or a UCB recipient by a subject, the parameters [including] name and identification of the clinic and/or a transplant center, name of the coordinator and the attending physician with contact data, status of the clinic with regard to international certifications (for example, FACT), average number of UCB transplants at the querying clinic over the previous three years, name, insurance number, and other billing data, medical history, indication and proposed treatment by the attending physician, urgency according to the defined classification, HLA type, blood group, weight, ethnic background, gender, age, known allelic characteristics, diagnostic results, and/or data from DNA typing or initial or repeat treatment,
b) Inputting genetic, molecular, or metabolic data of the at least one patient, UCB donor, or UCB recipient by another subject, whereby the genetic, molecular, and/or metabolic analyses are carried out by a service provider or a research institution, and these analyses are linked to the computer system via wired or wireless connections, and the genome, the proteome, and/or the metabolome are characterized,
c) Displaying the data input under a) and b) on an output device of the computer system, the data being editable, movable, combinable, or deletable by the first subject, and preferably represented in a comparison matrix, and
d) If necessary, access by a third party to the computer system, the data being only readable for the third party.

The invention advantageously relates to a machine-implemented method for allocating and selecting biological, biochemical, or chemical substances on a computer system consequent to a command issued by a subject, the computer system comprising processing units, in particular computers, medical systems, storage devices, and/or special processors by means of which data are exchanged, which are connected to one another via wired and/or wireless connections, characterized by:
e) Inputting parameters of at least one patient, UCB donor, or a UCB recipient by a subject, the parameters [including] name and identification of the clinic and/or a transplant center, name of the coordinator and the attending physician with contact data, status of the clinic with regard to international certifications (for example, FACT), average number of UCB transplants at the querying clinic over the previous three years, name, insurance number, and other billing data, medical history, indication and proposed treatment by the attending physician, urgency according to the defined classification, HLA type, blood group, weight, ethnic background, gender, age, known allelic characteristics, diagnostic results, and/or data from DNA typing or initial or repeat treatment,
f) Inputting genetic, molecular, or metabolic data of the at least one patient, UCB donor, or UCB recipient by another subject, whereby the genetic, molecular, and/or metabolic analyses are carried out by a service provider or a research institution, and these analyses are linked to the computer system via wired or wireless connections, and the genome, the proteome, and/or the metabolome are characterized,
g) Displaying the data input under a) and b) on an output device of the computer system, the data being editable, movable, combinable, or deletable by the first subject, and preferably represented in a comparison matrix, and
h) If necessary, access by a third party to the computer system, the data being only readable for the third party.

By inputting the patient data and supplementing them in a stepwise manner, using genetic, molecular, and/or metabolic analyses, the attending physician is able to recognize certain treatment corridors and/or discern exclusion criteria with regard to basically approved therapies and outline the treatments to the patients. The analyses may be carried out by appropriate service providers who, if necessary, have access to the computer system and are in connection with same via a network. However, it may also be preferred that the data that are determined by the service providers are supplied to the first subject, i.e., preferably the attending physician, who inputs them into the computer system. The data advantageously include RAW data that are compatible with the computer system and are preferably automatically input into same. The molecular, genetic, and/or metabolic data may also be obtained by a laboratory in the clinic to which the patient has been admitted. After entry into the computer system, the data are presented to the physician by means of imaging processes. Based on this stepwise approximation toward solutions via parallel or successive integration of diagnoses, analyses, or results and knowledge from scientific databases, it is now possible for the first time to ensure complex processes for customizing treatment when handling large numbers of patients.

The metabolome data of the patient preferably comprise all characteristic metabolic properties of a cell or a tissue, and include the following:
the flow rates (reaction rates), metabolite level, and enzyme activities of the individual metabolic pathways,
the interactions between the various metabolic pathways, and
the compartmentalization of the various metabolic pathways within the cells.

Another aspect is the influence of the nutrient supply as well as the effect of active substances on the metabolism and the various functions of the cell, such as cell proliferation, differentiation, and apoptosis. The metabolic analysis is focused on the interaction of the metabolites and their identification and quantification. GC/MS and LC/MS as well as NMR spectroscopy and ion mobility spectrometers, for example, are used as essential analytical methods in metabolic analyses, which within the meaning of the invention are also referred to as metabolomics.

Within the meaning of the invention, the proteome refers in particular to the entirety of all proteins in a living organism, a tissue, a cell, or a cell compartment under precisely defined conditions and at a specific time. The proteome may preferably be analyzed by molecular analyses. A distinction may be made between methods for separating the individual species of proteins (chromatography, gel filtration, electrophoresis) and methods for characterizing and identifying same (mass spectroscopy, sequencing, staining).

Within the meaning of the invention, in particular the entirety of the inheritable information of a cell is referred to as the genome or also hereditary material of a living organism, which is present as deoxyribonucleic acid (DNA). The genome is preferably analyzed using genetic analyses (for example, sequencing, DNA chips).

In a preferred embodiment of the system or of the method, characteristic data of the samples, the UCB preparations or samples (for example, blood, urine, feces, cells, tissues, bone marrow) of the patient are input via processing units such as computers. However, it may also be advantageous to automatically analyze the sample using one or more analytical devices and automatically transfer examined values into a processing unit. For example, samples may be rapidly and efficiently examined and characterized in so-called laboratory lines which represent a kind of serial arrangement of various analytical devices. The analyzed values are automatically entered into the system or the computer system and are thus rapidly available. The data, i.e., the values that are specific and characteristic for a UCB preparation or a patient, are advantageously stored on a storage medium. Within the meaning of the invention, the storage medium or a data memory is used for storing data or information. The data may advantageously be supplemented with additional data at any time and are preferably in digital form. It may be preferred that the storage medium is a mass storage device preferably having magnetic recording technology or semiconductor memory technology, or a flash memory. Within the meaning of the invention, a mass storage device refers to a storage medium which stores large amounts of data or information, preferably for a prolonged period of time. A mass storage device having magnetic recording technology may advantageously be used which writes binary data on the surface of a rotating ferromagnetic disk. Within the meaning of the invention, semiconductor memories are data memories composed of a semiconductor in which integrated circuits are implemented by means of semiconductor technology. The data are stored in the form of binary electronic switching states in the integrated circuits. This allows permanent and safe storage of the data.

Within the meaning of the invention, processers are service providers who refine the raw product of the cell, for example using so-called kits or so-called bioreactors, to obtain a better usable cell product. Within the meaning of the invention, refinement describes a purification and/or conditioning of cells or cell-containing solutions, including blood, by means of which in particular specific cell types may be isolated. It is possible to isolate cells that present with certain surface markers on their surfaces, in particular glycoproteins. Surface markers may include, for example, CD133, CD34, CD7, CD44, and/or CD24, where CD stands for “cluster of differentiation.” Surface markers that present on the surface of stem cells are preferred.

Within the meaning of the invention, a kit describes a set of parts which may be used to assemble something (in particular an assembly kit) or which is needed for a certain activity (for example, basic equipment, complete package). The kit is preferably used to easily and quickly isolate and purify specific cell types, i.e., to separate them from other cells or constituents. The kits advantageously identify and purify stem cells having at least one specific surface marker. After successful purification, the cells may be expanded, i.e., proliferated under cell culture conditions. Refinement is absolutely necessary for the treatment of various diseases.

This complexity is further increased by the necessity of balancing the continually renewing and growing inventory of stored preparations with a continually renewing and growing inventory of, for example, chronically ill patients, and providing the attending physician with the opportunity to initiate an order, delivery, and possible further processing of one or more preparations as soon as the system recognizes, based on comparing the inventory of preparations to the patient register, one or more solutions for the treatment of an individual patient.

In practice, this process operates as follows: the attending physician registers the patient in question in the system, indicating the necessary data such as, for example, HLA type, weight, or further molecular diagnostic data. The attending physician is able to prioritize and periodize the matching of patient data and the data of all available stored preparations, and define set data or time periods for ordering, further processing, and transplantation. The system is thus able to automatically search repeatedly and continuously for treatment solutions for each patient. At the bank, besides marking each preparation with the features that describe the preparation, the depositing party is able to mark, also using certain features, so that the preparation is available, for example, only for transplantation in leukemia patients, thereby automatically not incorporating it in patient searches involving other indications. Further features may include, among others, prioritizations or classifications, for example according to price, effectiveness, or probability of success. The system has the ability to automatically and dynamically compare large stored inventories of cells or biological materials (including UCB preparations) to the requirements of registered patients, recognize solutions for the required therapy as well as combinations from multiple stored preparations, and, if necessary, automatically initiate preliminary reservations.

Advantageously, data relating to patients and preparations (for example, HLA values or weight and cell number) are correlated by information processing systems and utilized for the evaluation of matches. The match is essentially based on a comparison of data of the UCB preparations with those of a recipient or patient. That is, the system compares, for example, the HLA value of the UCB preparations with those of the recipient. If one or more matches exist, the corresponding preparation is provided with a weighting that reflects the number of matches, and is presented to the physician. The blood banks advantageously provide the information regarding available UCB preparations (UCBP) in a decentralized fashion and also update same. The information relating to the available UCBP inventory is collected in a repository (database), for example, and provided for searches therein. To increase the efficiency and minimize errors, the search parameters used in weighting and automated selection may be stored centrally for attending physicians and clinics, for example. Thus, the default search parameter sets may be retrieved at the beginning of a search and optionally modified by an expert (expert mode). Advantageously, the search for suitable UCBP proceeds automatically, but can also be performed step by step or checked by a person skilled in the art. To prepare order processing, interaction with a blood bank may be necessary to initiate further or missing investigations. Up to now, this has been a manual and time-consuming step. The system advantageously supports the processes via an automated workflow, i.e., a working process that proceeds in a predefined sequence of activities within an organization. The workflow continuously informs about pending orders and the status of individual orders, thereby improving the quality of the results and making the processes per se more efficient and rapid. When tracking the delivered and transplanted preparations, the system is able to gather information required in medical and pharmacological terms. In a preferred embodiment, the system is also able to automatically create statistics relating to the processing speed and the rapidity of blood banks, as well as success statistics as a function of types of disease and UCBP parameters. Thus, the system user, for example the coordinator, is provided with a clear representation of handling and, using the latter, can optionally improve working processes or order processing, because the system user obtains useful evaluations of the blood bank, for example.

It may be preferred that fairly large patient registers are administered, and that automated matching between the inventory of preparations and the register of patients takes place, in particular when new preparations and/or patients are introduced. The system carries out a patient search in which individual, fairly large registers of patients having various indications, including acute myeloid leukemia (AML), dilative cardiomyopathy (DCM), diabetes mellitus, or ischemic stroke, are searched. This means that the system compares data of the UCB preparations with the data of the patients, and the system stores UCB preparations and patients, in particular having identical parameters and data sets, on a storage medium. Furthermore, the patients as well as the UCB preparations may be analyzed by molecular diagnostic analyses, thus generating genetic, molecular, and/or metabolic data. The system is thus able to compare the data of the UCB preparations with patient data and to identify matches, by means of which suitable preparations are quickly and easily found.

In addition, it is preferred that in order to provide a better usable cell product, further service providers, including diagnostics service providers, logistics service providers, and processers who purify the raw product of the cell, in particular using kits, are automatically connected to the system via a network which includes the automated selection of service providers as well as coordination of same by the system.

When processing the data, it is preferred that in particular all UCB preparations registered in the system and stored in various UCB banks or collection centers worldwide are acquired as parameters in an advantageously uniform data set (unit report). That is, the UCB preparations are preferably recorded using at least one of the following parameters and stored in the system:
Name and identification of the UCB storage bank
Status of the UCB storage bank with regard to international certifications (FACT, for example)
Process reliability of the UCB bank according to classification
Contact in the respective bank, including contact data
Approved purposes of use of the preparation
Identification number of the preparation
Medical history of the mother, child, and family according to patient history form of the clinic where birth occurred
Ethnic group of the mother, father, and/or child
Gender of the child
Date of initial storage of the preparation
Details of preparation processing
Blood group of the preparation
HLA type of the preparation
Cell count (TNC) of the preparation
Cell count (CD34+) of the preparation
Cell count (CD133+) of the preparation or other similar cell types
Viral status of the preparation
Allelic characteristics of the preparation.

The combined parameters are advantageously input into the system, and, surprisingly, allow unambiguous characterization of an umbilical cord blood preparation (UCBP) because, as a result of the entered data or combination of parameters, each preparation is defined by its specific properties or parameters. This is advantageously achieved by combined acquisition of the parameters. Within the meaning of the invention, a parameter describes a characteristic quantity, i.e., a characterizing property, that is inserted in the system in the form of data. The data advantageously include operational details (attributes) of patients, clinics, physicians, donors, blood banks, UCB preparations (laboratory values, physical and informational properties), order and process information, and controlling information including search/exclusion criteria, thresholds, and weighting factors. Parameters that are used for characterizing the preparations are acquired. In particular, the advantageous combination of parameters is not described in the prior art, and allows for unambiguous assignment and detection of a preparation. It is thus possible to set up a database, a UCBP database within in the meaning of the invention, in which the parameters are stored.

The parameters may be input locally, for example by the UCB bank, which may also maintain and update the system database. In addition to information relating to the UCB bank, such as name and identification of the UCB bank, the bank's status with respect to international certifications (for example, Foundation for the Accreditation of Cellular Therapy (FACT)) is stored, thereby ensuring compliance with defined standards regarding the quality of preparations. Advantageously, a contact person in the respective bank may also be entered together with contact data. For example, a contact may be an attending physician, or a coordinator responsible for maintenance of the database at the bank. Furthermore, a system-standardized identification (ID) number is preferably assigned which allows unambiguous assignment. Moreover, comprehensive searches for preparations from the UCB bank can be performed. In addition, process reliability details for each UCB bank are automatically collected by the system and included in the search. Furthermore, data relating to the medical history of the mother, child, and family are included in the database according to a patient history form of the maternity clinic. This advantageously allows assessment of the preparations with respect to specific diseases such as hereditary diseases. The ethnicity of the mother, father, and/or child is beneficial as information because specific genetic variations may be associated with the ethnic background and might therefore complicate a transplantation. Advantageously, parameters such as blood group, HLA type, cell count (total nuclear cells (TNC) and CD34+), viral status, and allelic characteristics of the preparations are also entered into the database. This comprehensive information allows characterization and identification of the preparations and, accordingly, optimum assignment of a recipient.

The data set of each preparation advantageously includes information as to whether the preparation has been frozen in segments (if so, how many) and with fragments (if so, how many) and with DNA samples (if so, how many). Fragments, segments, and samples are used in a subsequent detailed determination of the preparation with respect to a particular patient, and to check key data prior to transplantation. The system provides information as to how many segments, fragments, and DNA samples are available at the time of inquiry and/or which further tests, such as confirmatory typing (CT), high-resolution (HR) HLA typing, or colony assays (CA) have already been carried out, and/or what the results of these tests were. In addition, the status of a preparation is recorded, i.e., if and since when the preparation has possibly been reserved by a clinic.

Within the meaning of the invention, the database comprising the data or parameters may also be referred to as a data warehouse, i.e., a central data collection, the content of which is composed of data from different sources. The data warehouse not only manages all data of the individual preparations in each of the UCB banks, but also dynamically matches each entered preparation with all other preparations in the various UCB banks, thereby automatically documenting upon registration of each preparation which combination of preparations can be used for potential subsequent double or multiple transplantation (multi-cord).

Moreover, the database contains the patient registers, i.e., the data of all patients who are administered by the individual transplant centers or clinics, including patient-related data (HLA type, for example) and treatment-related data (indication or treatment frequency, for example), which are likewise incorporated into the dynamic match, so that when a new preparation is stored or a new patient is registered, an automated check is directly run in each case to determine whether a preparation can be used for a certain patient, either individually or in combination with other preparations for transplantation or therapy, the amount of time needed from the order, processing, and logistics until the time of the treatment and/or transplant, and the anticipated incurred costs and the probability of success.

The first classification criterion for a multi-cord match between the registered preparations is the HLA match. Matching is preferably present in at least four out of six HLA features, and those preparations having the most HLA matches are at the top in the order of suitability as multi-cord. Within the meaning of the invention, a classification describes a defined order of elements. Classification of the elements may be based on their properties, for example the parameters or attributes (UCB preparations, for example). Within the meaning of the invention, the classification criteria describe the way in which the classification is created (for example, all UCB preparations according to their TNC size from the largest down to the smallest preparation). It is advantageously possible to apply filtering criteria to a classification, which means that, for example, only those preparations having a defined TNC size are included in a search. It is particularly advantageous that, in the event of relatively large amounts of data, these classifications may be used as an index, for example to perform efficient searches (also as a combination using a number of criteria).

The second classification criterion is the blood group equality or compatibility. Again, preparations with blood group equality are at the top, followed by those having compatibility, and blood groups excluding one another result in nonsuitability as multi-cord with respect to certain other preparations.

The cell count (TNC, CD133+, or CD34+, for example), ethnicity, and allelic characteristics are carried along as information or characteristics of the preparations, and are used to determine the further order, i.e., whether the preparations would be suitable and if it would be advantageous to examine another feature of the preparations. Again, preparations with a high TNC count and a high CD34+ cell count are higher up. The same applies to identical ethnic origin and compatible allelic characteristics. Hence, possible pairings or groupings of matching preparations are identified and ranked in the data stock of the system, i.e., the data present in the database, even prior to inquiry by a clinic for an individual patient.

A further important classification criterion is the priority by which certain storage sites are preferred, assigned by the user based on his experience. In addition, when multiple preparations are used for a transplant, storage sites of previously selected preparations may be taken into account as a further classification, so that additional preparations are preferred, if possible, from the same or logistically favorably located storage sites. The classification criteria must also be analogously applicable for a single-cord transplant, in which case the data of one or more preparations are compared to those of a recipient.

The inquiring clinic preferably performs a patient search, wherein the determination of patient-compatible preparations includes the following classification and/or exclusion criteria:
Name and identification of the clinic or transplantation center
Name of the coordinator and attending physician, including contact data
Status of the clinic with regard to international certifications (FACT, for example)
Average number of UCB transplants in the inquiring clinic in the last three years
Name of the patient, insurance number, and other accounting information
Medical history of the patient
Indication and therapy proposal of the attending physician
Urgency according to defined classification
HLA type of the patient
Blood group of the patient
Weight of the patient
Ethnic group of the patient
Gender of the patient
Age of the patient
Known allelic characteristics of the patient and/or data of DNA typing
Initial or repeated treatment

Owing to the advantageous combination of classification and/or exclusion criteria, which have a synergistic effect in combination, a patient can be unambiguously characterized, it being advantageous to compare the data of a patient with stored data of a preparation in a UCB bank. The patient and the preparation are advantageously characterized using the same criteria, so that direct comparison is possible. The properties of the preparations may advantageously be compared with those of a patient, for example using a compatibility matrix in several stages and various classification criteria. The compatibility matrix allows direct and easy comparison of the properties of the preparations with those of a patient, and provides information as to whether the preparation is tolerated by the patient. Advantageously, a number of results, i.e., preparations, that would be optimal for a patient are presented to the attending physician. It is also advantageously possible to propose preparations for single-cords or multi-cords with regard to transplantation in a particular patient. The final decision as to which preparation or preparations should be used may advantageously be made by the attending physician.

Within the meaning of the invention, the criterion of indication and therapy proposal of the attending physician describes the diagnosis, analysis, and indication of the disease which the patient has (for example, acute myeloid leukemia (AML), dilative cardiomyopathy (DCM), diabetes mellitus, or ischemic stroke) and for which the attending physician suggests a particular treatment (therapy). The therapy proposal includes, among other things, determining the product to be used (for example, umbilical cord blood preparation in the form of a finished drug), date, course, and duration of treatment, as well as number, dosage, and administration of product(s) and possible measures in case of relapse.

Furthermore, within the meaning of the invention the criterion of urgency according to a defined classification describes prioritizing the search and assigning a suitable preparation for a particular patient versus a parallel search performed for another patient who might possibly use the same product because of that patient's genetic typings, the prioritizing representing a mandatory determination for all users of the database or platform. The classification table may be set by a coordinator, and is based on the medical urgency with which a patient requires the preparation.

The parameters that are important, for example for a particular patient and, as a consequence, important to the search for a suitable preparation, may advantageously be predefined by the attending physician or the clinic prior to the search, so that efficient and automated search processing is possible.

For example, information relating to the treating clinic is not only logged for process quality assurance but also collected as necessary information in advance, without which the search process cannot be started. Furthermore, the preferred embodiment automatically collects statistics for each clinic relating to number and type of transplants, thus simplifying the assessment of a clinic with respect to suitability for a transplant. In this way, clinics having little or no experience with transplants may be excluded very easily.

The urgency of a case, for example a transplant, is taken into account when prioritizing preparations in cases of conflict. The option of resolving potentially occurring conflicts with respect to reservation and ordering of UCBP is advantageous for the automation of operations. The prioritization information may be used to this end, among other things. It is also advantageous to collect information required for automated accounting. In particular in automated mass processing, this is a mandatory precondition, and significantly simplifies automation and thus substantially reduces the work steps.

Details or lists of suitable preparations may advantageously be retrieved at each level during the preferred automatic selection of a suitable preparation. This allows a clear view of the selection for a coordinator or skilled person performing the search.

The classification of potential umbilical cord preparations is preferably set as follows:

ML_{Prep}=match level according to HLA match between preparation and patient

$${ML}_{Prep} := \{ \begin{matrix}\begin{matrix}6 \text{:} {HLA}_{Prep} and {HLA}_{Pat} match in 6 out of 6 values \\ and blood group compatibility\end{matrix} \\ \begin{matrix}5 \text{:} {HLA}_{Prep} and {HLA}_{Pat} match in 5 out of 6 values \\ and blood group compatibility \\ \begin{matrix}4 \text{:} {HLA}_{Prep} and {HLA}_{Pat} match in 4 out of 6 values \\ and blood group compatibility \\ Preparation not included \text{:} other\end{matrix}\end{matrix}\end{matrix}$$

CF_{Prep}=cell factor defines the required number of cells per kg of patient weight at corresponding match level

$${CF}_{Prep} := \{ \begin{matrix}3 \times {10}^{7} : {ML}_{Prep} = 6 \\ 4 \times {10}^{7} : {ML}_{Prep} = 5 \\ 5 \times {10}^{7} : {ML}_{Prep} = 4\end{matrix}$$

CN_{Prep}=classification number of a preparation allowing arrangement of preparations in accordance with TNC and match level

$${CN}_{Prep} := \frac{{TNC}_{Prep}}{{CF}_{Prep}}$$

SL_{Single}=short list of preparations to be considered for single transplants

$${SL}_{Single} := \{ p ∈ Prep \vert \frac{{CN}_{p}}{{BW}_{Pat}} \geq \frac{1}{kg} ⋀ {ML}_{Prep} \geq 4 \}$$

The standard classifications of preparations in a short list are made according to the following criteria:

Classification 1=initial ranking according to match level, followed by classification number, followed by cell number of CDXX⁺

$$Classification 1 ( SL ) := \{ \begin{matrix} \\ p 1 ∈ SL , p 2 ∈ SL \vert \begin{matrix}either {ML}_{p 1} > {ML}_{p 2} \\ or {ML}_{p 1} = {ML}_{p 2} {CN}_{p 1} > {CN}_{p 2} \\ \begin{matrix}or {ML}_{p 1} = {ML}_{p 2} {CN}_{p 1} = \\ {CN}_{p 2} {CDXX}_{p 1} \geq {CDXX}_{p 2 }\end{matrix}\end{matrix} \\ \end{matrix} \qquad$$

Classification 2=initial ranking according to classification number, followed by match level, followed by CDXX⁺

$$Classification 2 ( SL ) := \{ \begin{matrix} \\ p 1 ∈ SL , p 2 ∈ SL \vert \begin{matrix}either {CN}_{p 1} > {CN}_{p 2} \\ or {CN}_{p 1} = {CN}_{p 2} {ML}_{p 1} > {ML}_{p 2} \\ \begin{matrix}or {CN}_{p 1} = {CN}_{p 2} {ML}_{p 1} = \\ {ML}_{p 2} {CDXX}_{p 1}^{+} \geq {CDXX}_{p 2 }^{+}\end{matrix}\end{matrix} \\ \end{matrix} \qquad$$

where

Prep=Umbilical cord blood preparation

Pat=Patient

HLA_{Pat}=HLA values of the patient

HLA_{Prep}=HLA values of a preparation

TNC_{Prep}=Number of nucleated cells of a preparation

BW_{Pat}=Body weight of the patient in kg

CDXX⁺_{Prep}=Number of cells which in particular include surface markers from the group “cluster of differentiation” comprising CD34 and/or CD133.

Accordingly, the preferred embodiment is also a combination in which the above-mentioned elements cooperate to achieve an overall technical success, thereby creating a synergistic effect which is reflected in a surprisingly efficient and rapid search for adequate preparations. Therefore, the classification criteria within the meaning of the invention may also be referred to as search criteria. The search may advantageously be performed automatically, so that the search can proceed much more quickly, and errors by individuals involved in the search do not occur. Standardizing the search process and combining the classification criteria advantageously allows automated mass processing.

The search for a suitable preparation proceeds in several steps. The first step is a basic search. According to an exclusion principle, a so-called “long list” advantageously includes a ranking of all those preparations which match in at least four out of six HLA typings and do not exclude each other with respect to their blood group affiliation; i.e., the result is a match level in accordance with the HLA matches between preparation and patient. At this point in time, the clinic can also import preparations from non-registered UCB banks into the basic search.

The next step is an advanced search in which a two-part short list can be utilized with advantage. The list advantageously includes possible single transplants (single-cord view). This involves preparations which are possible as single transplants with respect to correlation of the classification criteria of HLA match, patient weight, number of so-called nucleated cells (TNC), and number of hematopoietic cells (CD34+), CD133+ cells, and other cell types. The correlation is based on the following characteristic values: given an HLA match of six out of six, the patient requires, for example, at least 3.0×10⁷ TNC/kg body weight of the patient; i.e., if the patient has a body weight of 55 kg, for example, the preparation may have a total of at least 1.65×10⁹ nucleated cells. Given an HLA match of five out of six, the same patient requires, for example, at least 4.0×10⁷ TNC/kg body weight, so that the preparation may have at least 2.2×10⁹ TNC if the patient's weight is 55 kg, for example. Further, given a match of four out of six HLA types, the preparation may have at least 5.0×10⁷ TNC/kg, i.e., a total of 2.75×10⁹ TNC. Thus, rankings of the identified preparations may advantageously be established, for example according to two selectable criteria: 1) highest HLA match, followed by highest relative cell number; or 2) highest relative cell number, followed by highest HLA match. If the identified preparations are equal in their positioning, further ranking of the preparations is selectively determined by the level of the cell count of CD34+, CD133+, or other cell types.

By means of the preferred embodiment, in particular by virtue of the combination of criteria cooperating synergistically, the most suitable umbilical cord blood preparation may be identified in a given stock of UCB preparations and prepared for shipment. The process of selecting the preparation is advantageously automated. Thus, it is possible to standardize and speed up the time-consuming manual selection process which currently represents the key vulnerability in the supply chain of umbilical cord blood preparations.

It is also preferred to use and individually weight the following classification criteria and/or exclusion criteria:
Priority of the storage site based on user settings, the banks being sorted in a sequential order and/or a positive/negative list, thereby generating a personal ranking
For multiple preparations, the storage site of previously selected preparations in order to advantageously obtain several preparations from the same storage site or from another logistically advantageous storage site
Approved purpose of use of the preparation by the storage site
Estimated time until delivery of the preparation
Estimated cost of a preparation
Probability of success when using the preparation for the indication of the particular patient
Preparations having a CD34+ cell count above 10% of the TNC count
Exclusion of preparations in which less than 75% of the CD34+ cells survived and/or were activated in a colony assay (CA)
CD133+ or cells with CD surface molecules
Blood group identity
Ethnic identity
Gender
Age of the preparation
Accreditation standard
Ranking of the UCB bank, in particular by means of evaluations from all customers of this bank via personal prioritization of the user and/or ranking of the UCB bank based on the first selected preparation in a multi-preparation search, based on logistically advantageous criteria.

Within the meaning of the invention, the classification criteria or exclusion criteria may also be referred to as parameters. By use of the preferred embodiment it may be ensured that optimal quality of the preparations is guaranteed, thus allowing successful transplantation. To this end, preparations having a CD34+ cell count above 10% of the TNC count are advantageously weighted differently. Preparations in which less than 75% of the CD34+ cells survived and/or were activated in the colony assay (CA) are excluded in order to ensure a high number of hematopoietic stem cells. Other criteria such as blood group identity, ethnic identity, and gender may further circumscribe the selection of a preparation. Furthermore, old preparations may be excluded by determining the age of the preparation, so that only those preparations not having exceeded a defined age are advantageously used for transplantation, thus ensuring surprisingly high quality. The accreditation standard and ranking of the UCB bank may also be used for the selection. In this way, banks having, for example, little experience with storage or transplantation of umbilical cord blood may be excluded. The combination of classification criteria and/or exclusion criteria allows qualitative characterization of the preparations, thus reducing rejection of the preparations in transplantation and ensuring that a patient receives the “best,” i.e., the best tolerated, preparation.

It is advantageously possible to establish selection criteria which may facilitate the search for a suitable preparation and also simplify the selection of a preparation. To this end, it is also possible to use information, automatically collected by the system, concerning the reliability and delivery speed of the UCB.

Depending on the clinic policy, these additional classification criteria may be assigned once or re-prioritized in particular cases. Prioritization decides the fine selection in the final ranking of the preparations for possible solutions.

It is also preferred to use the preferred embodiment for allocating double or multiple transplantations (multi-cord). It is thus possible, depending on the required number of cells, to carry out double or multiple transplantations. This allows a double or multiple transplantation to be carried out as a function of the required cell count. That is, if the patient requires more cells than a suitable preparation can provide, an additional suitable preparation may be automatically searched.

Furthermore, the selection of multi-cord preparations is preferably performed according to the following classification criteria:

ML_{P1P2}=Mutual compatibility of two preparations:

$${ML}_{P 1 P 2} := \{ \begin{matrix}\begin{matrix}6 \text{:} {HLA}_{Prep 1} and {HLA}_{Prep 2} match in 6 out of 6 \\ values and blood group compatibility\end{matrix} \\ \begin{matrix}5 \text{:} {HLA}_{Prep 1} and {HLA}_{Prep 2} match in 5 out of 6 \\ values and blood group compatibility \\ \begin{matrix}4 \text{:} {HLA}_{Prep 1} and {HLA}_{Prep 2} match in 4 out of 6 \\ values and blood group compatibility \\ Preparation not included \text{:} other\end{matrix}\end{matrix}\end{matrix}$$

BL_{Multi}=Basic list to determine the selection list for multiple preparations

$${BL}_{Multi} := \{ p ∈ Prep \vert \frac{{CN}_{p}}{{BW}_{Pat}} < \frac{1}{kg} ⋀ {ML}_{Prep} \geq 4 \}$$

SL_{Multi}=Short list of preparations to be included in multiple transplants

$${SL}_{Multi} := \{ p 1 ∈ {BL}_{Multi} , p 2 ∈ {BL}_{Multi} \vert {ML}_{p 1 p 2} \geq 4 ⋀ \frac{{CN}_{p 1} + {CN}_{p 2}}{{BW}_{Pat}} \geq 1 \}$$

The preferred embodiment provides a second part of the short list, i.e., the multi-cord view with preparations that are matched to one another. The suitability of different preparations with respect to one another is advantageously already defined, so that advantageously there are no incompatibilities between multiple preparations administered to the patient. The short list advantageously includes preparations previously not considered alone or in combination, so that the required number of cells is either achieved or even surpassed. In multi-cord preparations the (partial) preparation having the higher CD34+, CD133+, or other comparable cell count is regarded as advantageous (the “first”), depending on the indication for which the search is carried out. A comparable cell count or cells preferably include(s) cells presenting with surface markers, i.e., surface molecules of the “cluster of differentiation” group on the surface that are in particular specific for stem cells. A preliminary budget for each single-cord and multi-cord appears on the short list, which calculates the cost of a preparation according to standard values in accordance with the status of the preparation, as well as the expected delivery time and probability of success of the treatment.

The search results may advantageously be represented in a “compare view” including up to four preparations which can be compared with the patient data in a straightforward manner. The “compare view” compares all data of the unit report with the data of the patient.

The search results can advantageously be represented in a “compare view” including up to four preparations that can be compared with the patient data in a manner that is easy to follow. The “compare view” compares all data of the unit report with the data of the patient.

The last step of the selection process involves proposed solutions advantageously presented to the attending physician in a clear and concise manner. The proposals advantageously comprise single preparations and/or multi-cord preparations. Whether a single-cord or multi-cord is used, and if so, what type, is the final decision of the physician.

A folder/file having four sheets may advantageously be created for each proposed solution. This file is a working and communication tool for the cooperation between coordinator and attending physician or with respect to patient and clinic administration.

For example, the folder may be structured as follows:

Sheet 1 may be a worksheet or control slip showing the preparation(s) beside the patient data and illustrating the required subsequent steps to be processed until the point of transplantation. This involves in particular the requirements of HR typing, DNA samples, CAs, as well as direct communication with the respective UCB bank, reservations up to binding purchase orders, shipment logistics, integration of processers, and accounting up to delivery to the clinic administration.

Sheet 2 of the proposed solution may include the complete unit report(s).

Sheet 3 of the proposed solution may be used to document the decision; it summarizes the decision criteria of the physician, notes the final budget, and is signed by the physician. The physician can use this sheet to point to other proposed solutions to be alternatively used if the desired proposal cannot or can no longer be implemented due to particular events.

Sheet 4 may include a clear description relating to the preparation, temporal course, and transplantation in general, which is available to the physician for patient consultation, or to the patient.

Furthermore, if the first solution cannot be achieved (for example, due to shipping damage or loss of a preparation from the first solution), proposed solutions may advantageously be documented in an annex to the file.

In addition, advantageously suggested solutions can be documented in the attachment to the file should the first solution prove impossible to implement (for example, due to damage sustained in transit or loss of a preparation from the first solution).

The sheets of the proposed solution are available to the clinic for the further course such as accounting and tracking of the transplantation, for example the patient's medical history, and passed on to the respective UCB bank(s) at the appropriate time.

During the entire course and up to the aftercare of the patient, data of newly registered UCB preparations are advantageously automatically transmitted to the clinic and evaluated in terms of ranking on the long list and short list, as well as proposed solutions.

This ensures dynamic improvement of the proposed solutions and subsequent treatment of the patient on the basis of the most recent data inventory.

In a preferred embodiment, a cell preparation suitable for allogeneic transplantation is selected. In allotransplantation, the transplanted tissue is derived not from the recipient, but from a donor of the same biological species. To avoid serious or even fatal rejection of foreign tissue, preferably complete matching of features recognized by the immune system with the host tissue is required for successful allogeneic transplantation. On the basis of preset parameters, it is possible by means of the preferred embodiment to perform an easy, rapid, and advantageously automated search for a suitable, i.e., matching, preparation, so that—quite surprisingly—the risk of rejection is minimized and successful transplantation is not obstructed in any way.

In another preferred embodiment, an automatic and full-range selection of single-cord or multi-cord transplants is performed, wherein appropriate preparations which match in their parameters and do not generate any rejection responses are proposed to the attending physician and/or the coordinator. Advantageously, preparations matching one another and the patients are appropriately displayed so as to significantly simplify and speed up the selection. The attending physician may thus receive a representation of the two choices and come to his own judgment as to whether a multi-cord or single-cord transplantation should be performed. Surprisingly, as the result of automatic selection, errors may be avoided, and single-cord or multi-cord transplants may be presented to the attending physician. The presentation advantageously proceeds in a clear and concise manner, thus facilitating the selection of preparations by the physician.

The search criteria are preferably adapted to the entered criteria and/or parameters. The current typing status of the UCBP is taken into account when selecting a suitable preparation. For example, this implies an assessment as to which additional investigations, etc. are necessary so that the preparation can be confirmed as suitable and can be transplanted. To this end, the preferred embodiment preferably utilizes automatically collected statistics on the expected costs and the required time. This is absolutely necessary in particular in time-critical scenarios, and substantially speeds up the selection process. In general, the extendability of the data scheme of UCBP and patient is advantageous in that additional search criteria may be adapted to a future state of the art.

It is also preferred that a matrix is used to display the results obtained using the search criteria, and that the results are visually displayed. To this end, the preferred embodiment provides a visual guide as to the best search results according to the currently selected search parameters. For this purpose, the search results are arranged in a matrix and displayed. The matrix can be dynamically rearranged according to various criteria. Matching with respect to preset search criteria is displayed in colors. Within the meaning of the invention, the matrix may be described as a heat map in which data of a parameter are displayed as colors in a two-dimensional representation.

It is also preferred that statistics relating to the expected costs and the required time are used to assess the status of the determination of classification criteria. Statistics relating to the search for a suitable preparation may advantageously be used for the determination of classification criteria. For example, the expected costs, required time, successful transplantations of a clinic, and investigations still to be performed may be included in the selection of a preparation or in the classification assumed by a preparation. This allows preparations to be assessed more quickly and arranged accordingly. In addition, a cost- and time-saving search is possible.

Automatic and complete proposals of solutions for single-cord or multi-cord transplants may be developed in this way. The coordinator and the physician may advantageously focus on the suitability of various well-defined and well-documented proposals of solutions. Coordination between clinic, diagnostics and logistics service providers, processers, transplant center, and attending physician is preferably carried out by means of the preferred embodiment. This ensures reliable communication between the clinic, i.e., optionally the attending physician, and the transplant center, as well as any other involved parties. The search parameters and the results are presented in a clear and concise manner, thus significantly facilitating the selection. Also, the parameters forming the basis of the search are variable and can be adapted to the patient and/or the sought preparation. This is a great improvement over the current situation in which coordinators are obliged to assess potential transplants at a very early stage according to various criteria. At present, this leads to unsatisfactory results and is exceedingly time-consuming and labor-intensive. Thus, the preferred embodiment allows searching and ordering of one or more suitable preparations within a short period of time.

The invention will be explained below by way of example, but is not limited to the examples.

A medical cardiology clinic has a register containing data of well-qualified patients suffering from dilative cardiomyopathy (DCM). Cardiomyopathies relate to diseases of the heart muscle. In cases of dilative cardiomyopathy (DCM), initially the left ventricle (cardiac chamber) is considerably enlarged, and over the further course of the illness all the other cardiac chambers become greatly expanded (the heart may be compared to a large, flaccid sac). The wall strengths are usually thickened only minimally or not at all (hypertrophy). The contractions of the heart are restricted (systolic functional limitation), often in combination with asynchronous contractibility of the cardiac chamber due to a disruption of the excitation conduction as the result of a left bundle branch block. The causes of DCM may be rooted in a history of myocarditis or chronic alcohol abuse. There are also congenital forms of DCM. A secondary form is “ischemic DCM” as the result of coronary heart disease or the final stage of a hypertensive heart. DCM is a common reason for heart transplants if the patient does not sufficiently improve with medication, coronary intervention, or cardiac resynchronization therapy (CRT). After a clinical suspicion of the disease including the typical symptoms, the diagnosis is confirmed using imaging technology (echocardiography, MRI, MSCT) and tissue analysis (myocardial biopsy). Coronary heart disease must be excluded by cardiac catheterization, which could provide a curative treatment option.

Aside from other medical and diagnostic parameters (for example, TNC, blood group, etc.), HLA typing is also conducted on patients contained in the register. Since to date no medications are available for a causally based therapy, clinical development with mesenchymal stem cells has been conducted which demonstrates that an injection of these stem cells directly into the affected tissue of the heart muscle can improve the pumping function of the heart and ameliorate the cardiomyopathy. As of recently, the direct injection of stem cells into the heart and the affected tissue can be achieved by the so-called NOGA system. With the aid of the NOGA navigational system or NOGA mapping, it is possible to survey damaged areas of the heart muscle by careful electromagnetic mapping of all the heart chambers. A three-dimensional model of the mapped areas is computed on the basis of these data. Based on the obtained measured signals, in particular stem cells are subsequently injected in a targeted and selective manner into the edge area of the affected cardiac region using a specialized, fine NOGA injection needle. It is advantageously possible to make injections in several sites or regions of the heart. For this purpose, it is advantageously possible to use a catheter system which allows a catheter to be introduced through the femoral artery into the left ventricle of the heart. By laser-controlled guiding, the cardiologist can either remove tissue from the affected area for further analysis (biopsy), or inject stem cells directly into the affected tissue via a retractable needle.

This highly advanced method allows, for the first time, the placement of “large” cells in sufficient quantities directly into the affected tissue without the loss associated with an intravenous administration and/or plugging up the arterial system of the heart due to inexact placement.

A further innovation and a further prerequisite for treating DCM patients with stem cells are the regulatory approvals for selection kits by leading manufacturers, which make selection and concentration of important stem cells possible, in particular CD133+ from basic material such as bone marrow or also umbilical cord blood, in sufficient quantities for the causal therapy in DCM when administered using the NOGA system. To date, all clinical studies for stem cell therapy in treating DCM have been conducted using autologous cells. This means that the patient's own bone marrow was extracted and processed using the kit, and the concentrated CD133+ cells were transfused using the NOGA system. This method is already being used in clinical practice; however, it has the disadvantage that most patients no longer have a sufficient number of active stem cells in their bone marrow due to old age and/or accompanying medical conditions. Thus far, the application or administration of allogeneic stem cells has been unsuccessful because no system has been available that would allow, for example, identifying preparations from an inventory of umbilical cord blood that are a feasible option for the individual patient and that would notify the attending physician in a timely manner when a sufficient quantity of preparation or cells was available for that patient.

Surprisingly, this problem has been solved by the technical teaching according to the invention. When the order is placed by the physician, the system automatically ensures that the preparations which are part of a proposed and selected solution are ordered from the various UCB banks, and at the same time are sent for further processing to the service provider, which performs the selection of CD133+ or other cells and in accordance with the physician's criteria sends the preparations in a timely manner to the clinic for treatment purposes. This process thus represents a significant improvement over the systems disclosed in the prior art, which do not describe the automatic ordering and shipping. The system coordinates a transplantation of stem cells, for example, between clinics and UCB banks in the shortest amount of time. The considerably improved coordination results in a time savings which may be a matter of life or death for a DCM patient. In this regard, the system is able to exclude UCB preparations which, for example, are stored only for the restitution of hematopoiesis, from the cardiac search process, or to select same according to optimization criteria. This allows matching preparations to be found and automatically ordered in considerably less time. The same applies for pricing, which can be controlled by a supply-demand mechanism. These functionalities are important features to help umbilical cord banks operate in a cost-effective manner.

The system allows all data relating to chronically ill DCM patients to be stored, and for recurring therapy requirements, to be continuously matched against the continually renewing inventory of umbilical cord blood preparations in the system, as well as to automatically notify the attending physician in accordance with his criteria of new therapy options so that he may place another order at any time, if needed.

The same method may advantageously be used for all patients with cardiac insufficiency who undergo open-heart surgery by a heart surgeon, for example during a bypass operation. In this case, use of the NOGA system is not necessary.

The ordering and search for a suitable preparation is described below by way of example, without being limited thereto.

The ordering and search may include the following steps:

### 1. New Patient

### 1.1 Selection of the Physician/Clinic

The patient's physician places a written search order for a suitable umbilical cord blood preparation (UCB preparation). The indication for a stem cell transplant is confirmed at the same time, so that an unauthorized search for a UCB preparation, and thus blockage of the UCB preparation for other search processes, is ruled out. The patient is assigned to a physician and a clinic within the system.

### 1.2. Creation of a Patient File

A patient file, advantageously a digital patient file, is thus created. For example, the following patient data may be entered into a template having the following parameters:

| | | |
|---|---|---|
| Entry of patient data: | Name: | H. K. |
| for example, | Age: | *1949 |
| | Gender: | Male |
| | Body weight: | 90 kg |
| | Diagnosis: | AML high risk group |
| | HLA values: | A*2301, 6801 |
| | | B*3501, 4403 |
| | | DRB1*1501, 1601 |

The templates or parameters are variable, and may advantageously be supplemented with additional information.

### 1.3. Defining a Search Profile

The search profile defines which UCB preparations are suitable, for example:
TNC (total nucleated cell count=number of nucleated cells); minimum quantity of
TNC for the patient: 3×10⁷/kg of patient. (For patient H. K. with a body weight of 90 kg, a TNC of 270×10⁷ in the UCB preparation is correspondingly needed.)
Number of CD34+ cells in the UCB preparation.
Match of HLA values of patient and UCB preparation. HLA values advantageously match in four out of six parameters.
Presence of a precise specification of the UCB preparation by the UCB bank (unit report).

Additional individual search parameters may be defined. However, the search coordinator conducting the search may also use preset search profiles.

### 2. Beginning the Search

### 2.1. Single Transplant Search

After the patient data have been entered into the system and the search parameters defined, the program conducts the matching process; i.e., the characteristic properties of a preparation are compared to those of the patient. The parameters of the search profile are used as a filter. Based on the inventory of all reported UCB preparations, a list of matches is generated for patient H. K., advantageously based on compatibility, i.e., in agreement with the parameters.

### 2.2. Multi-Transplant Search

If no UCB preparation containing an adequate cell concentration (TNC) is found which may be used for the single stem cell source for the transplant, a search may advantageously be made for another matching UCB preparation in order to provide sufficient cells for a successful transplant. To this end, a multi-transplant search may be carried out. The match list is the basis for this further search process. The match list may be sorted according to the individual criteria of the search coordinator. A search for a UCB preparation may be made once again. Advantageously, four out of six HLA values should match the patient as well as the first UCB preparation. New matching lists are generated for this purpose.

### 3. Generating a Solution

Based on the new match lists, several solutions may result for a multi-transplant search for patient H. K. Nevertheless, a minimum quantity of 270×10⁷ cells in the UCB preparation is advantageous.

### 3.1. Solution Report/Reservation

The various possible solutions are evaluated by the search coordinator. The final selection can be presented to the attending physician in the form of a report. Following a thorough review, the attending physician decides on the selection of the individual UCB preparations.

Orders are placed with the UCB bank for each UCB preparation selected:

The UCB preparation could be reserved for the patient, this being advantageously confirmed by the UCB bank. Without a reservation, availability of the transplant is not guaranteed. If a reservation is not possible, a different UCB preparation can be selected. At this point, the search starts over.

### 3.2. Verification

A verification may be run for all UCB preparations that have been defined as a solution. This includes, for example:
A DNA sample may be requested for any UCB preparation. Shipping and receiving is processed and confirmed via the system.
The search coordinator may order high-resolution typing from the UCB bank. The UCB bank reports the typing results via the system.

This system of order placement and confirmation of receipt ensures that all necessary verifications of the selected UCB preparations are handled very rapidly and efficiently. The duration of order processing is precisely stipulated by the UCB banks.

3.3 After transferring all relevant data for the particular UCB preparation, the search coordinator makes the final selection of the solution approaches in consultation with the attending physician.
3.4 The defined solutions are advantageously divided into first and second choices, depending on the quality of the UCB preparations. Advantageously, a backup solution is available so that matching UCB preparations are available at the time of the transplantation.

### 4. Ordering UCB Preparations

4.1. The UCB preparations are requested as soon as the attending physician has set a transplant date. The UCB bank is notified of this date as soon as possible so that the necessary preparations can be made. This includes in particular provision of a nitrogen container for transporting the UCB preparations. The UCB bank organizes the actual transport, since it has the information concerning when the transplant is ready for pick-up. If the UCB bank determines that transport is not possible, for example because the UCB preparation has been damaged, the backup solution may be used.
4.2. After the transplant center receives the UCB preparation, an inspection takes place as to the proper condition of the nitrogen container in which the preparation has been transported, and the UCB preparation is checked and reported to the UCB bank; for example, any interruptions of the cooling chain may have dramatic effects on the viability of the cells in the UCB preparation.

### 4.3. Incoming Inspection of UCB Preparations

The laboratory at the transplant clinic may once again determine the HLA values, determine the cell count after thawing of the UCB preparation, and check the vitality of the cells. The UCB preparation is available for use for the patient after this incoming inspection.

### 5. Transplantation

The transplantation advantageously occurs immediately following the incoming inspection due to the need for immediate administration of the cells of the UCB preparation.

The processes from 4.1 to 5 may be carried out for each UCB preparation. In particular for multi-transplant requests originating from different UCB banks, careful coordination of the order is necessary to ensure that the various UCB preparations arrive at the transplant center at the same time.

### 6. Follow-Up

The initial clinical data for the patient (for example, conditioning protocol, underlying illness, previous chemotherapy protocols) may be collected after the transplantation. This may be immediately followed by recording of the transplant process, for example:
Duration of engraftment (incorporation of the transplant)
Duration until transplant functionality is attained
Clinical problems caused by a possible rejection reaction.

These extensive clinical data are advantageously also reported to the UCB bank, since such information is important for quality assurance. Follow-up takes place at regular intervals after a transplant.

The greatest advantage of cryopreserved UCB preparations in contrast to donor preparations (bone marrow, peripheral blood) is their immediate, ready-to-use availability. In practice, this immediate availability can only be realized by a system as described above.

The invention is now described by way of example with reference to the figures, without being limited to the examples. The figures show the following:

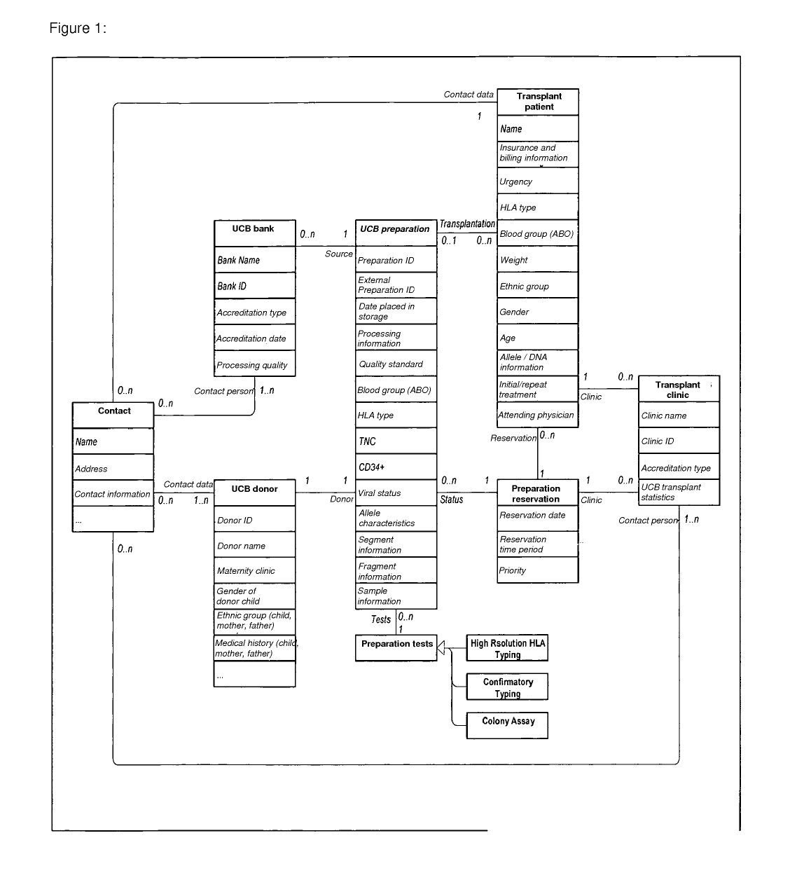

FIG. 1 shows the basic data model;

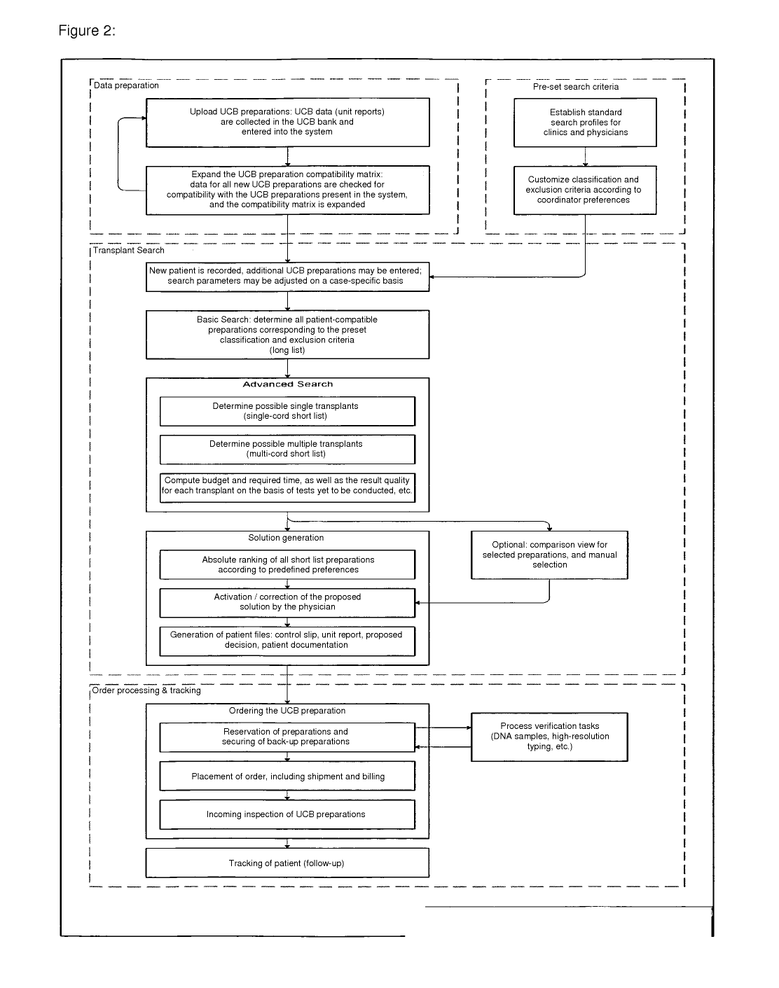

FIG. 2 shows the process flow;

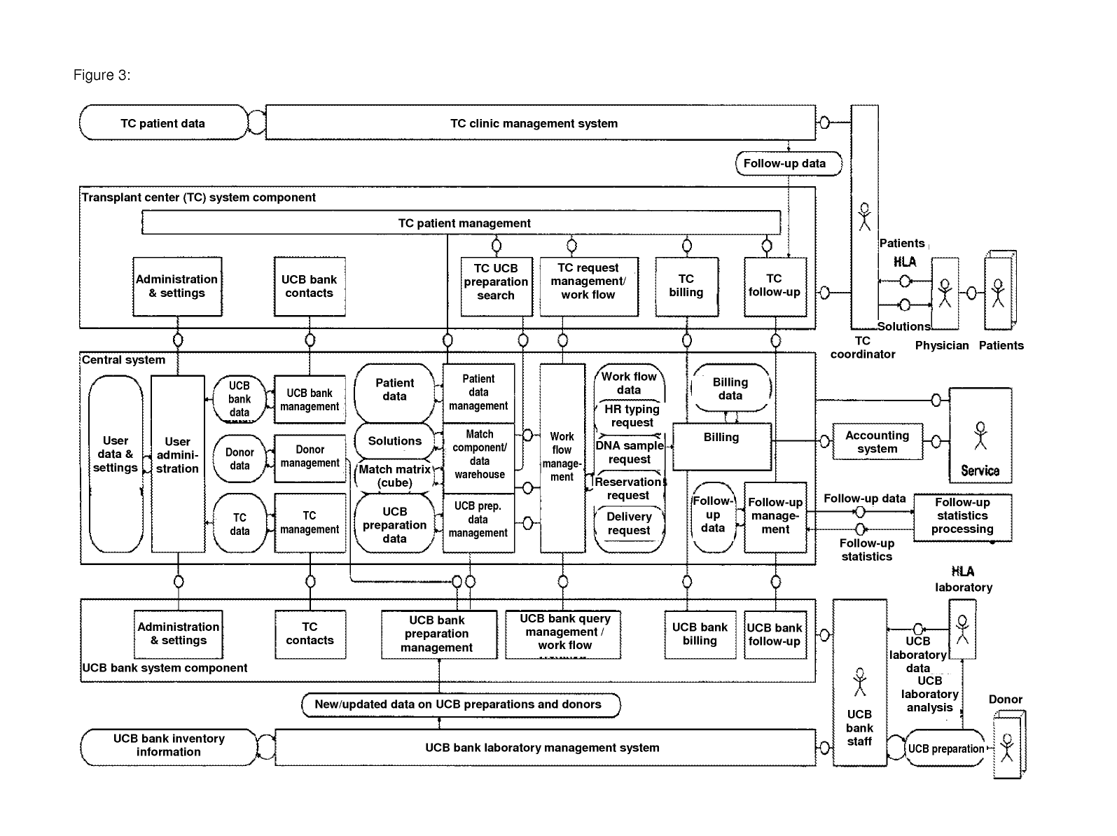

FIG. 3 shows the system architecture;

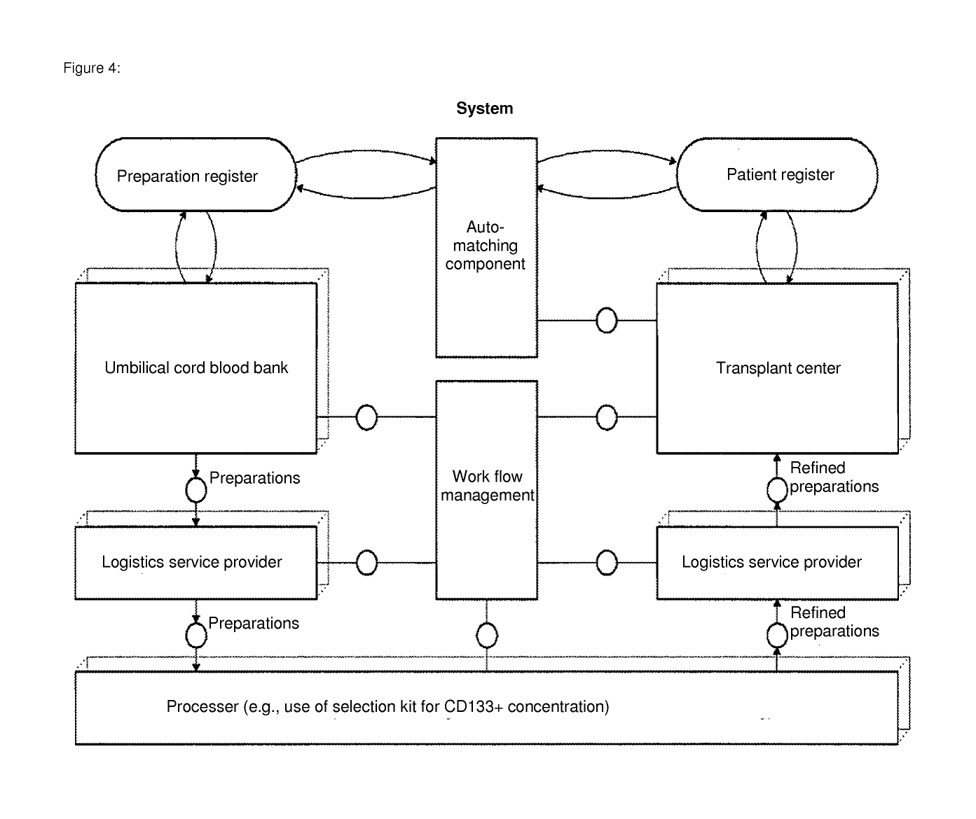

FIG. 4 shows a high-level overview of the system; and

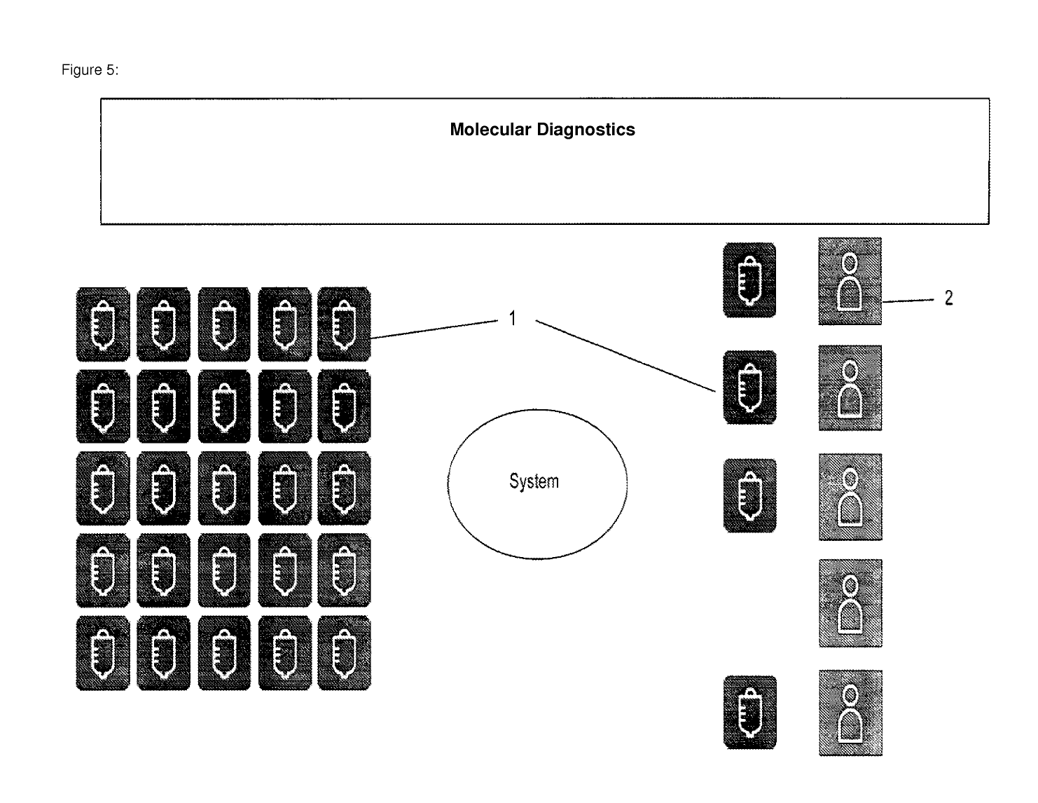

FIG. 5 shows the preferred use of the system.

FIG. 1 is an illustration, by way of example, of a preferred embodiment of the basic data model. In a first contact, the data of an individual, such as name, address, and other contact information, may be recorded. For example, this may involve a UCB donor, in which case additional data may be input into the database (including maternity clinic and medical history of the mother, father, and/or child). The UCB bank data may also advantageously be collected and stored. Advantageous data include processing quality and a specific bank ID. The data of the UCB preparations advantageously include HLA type, TNC count, or viral status. This information may be used to accurately characterize a preparation, and additional details of the preparation may be determined by further testing (including high-resolution HLA typing or colony assays). The preparation is examined using the tests, and the quality may be easily assessed. The data of the preparation are advantageously compared with the data of a transplant patient; i.e., it is possible to compare blood group and urgency, for example. It is also advantageously possible to analyze the genome, proteome, transcriptome, epigenome, and/or metabolome data of the recipient, i.e., the patient, or the UCB preparation. Based on this comparison, the preparation may advantageously be reserved for the patient by the transplant clinic. This may be done by a coordinator or an attending physician in the clinic. Advantageously, data of the clinic may be recorded and stored in a preferred database. These data include clinic ID or accreditation type. It is thus possible to precisely describe the course of the transplantation and detect complications at an early stage.

FIG. 2 is an illustration of the process flow by way of example. During data preparation, which refers to the process of entering the data of new UCB preparations and patients, new UCB preparations may be acquired in the UCB bank and imported into the preferred system. The newly acquired preparations may advantageously be compared for compatibility with UCB preparations present in the system. This may advantageously be carried out using a compatibility matrix, for example. When searching for a UCB preparation, the standard search profiles for clinics and physicians may be used, in which event it is also possible to advantageously individualize classification and exclusion criteria according to coordination preference. Furthermore, the search for a UCB preparation suitable for a transplant patient may be adapted in a case-specific manner. A so-called basic search may be conducted in which all patient-compatible UCB preparations are advantageously searched in accordance with preset classification and/or exclusion criteria (long list). Furthermore, it may be advantageous to perform a so-called advanced search in which possible single transplants (single-cord) and/or multiple transplants (multi-cord) are determined. It is also advantageously possible to list the required budget, the time needed, and the quality of results per transplant on the basis of tests still to be performed. This may involve a comparison of the retrieved preparations in a comparison view which also allows comparison of single preparations. Advantageously, a solution can be generated in which the short list preparations are arranged according to predetermined references. In this way, a clear and concise representation of preparations can be presented to the attending physician, and the proposed solution which is generated can advantageously be confirmed or corrected by the physician. The solution thus generated may be incorporated into the medical record of the transplant patient, which includes control slips, unit report, proposed decision, and patient documentation. Thus, all information relevant to a UCB transplantation may advantageously be stored in a file. Once the transplant clinic or the attending physician has selected one or more UCB preparations, the preparation can be ordered from the UCB bank. The preparations retrieved by the search may advantageously be reserved for a patient or a clinic, and backup preparations may advantageously be determined in case the selected preparations are not available. Furthermore, additional verification (including DNA samples, high-resolution) may ensure the quality and compatibility of the preparations. Following selection, the preparations may be ordered and delivered. The preparations advantageously undergo incoming inspection in the clinic. A patient follow-up may advantageously be performed after successful transplantation.

FIG. 3 is an exemplary illustration of the preferred system architecture. The illustration shows a schematic configuration of a preferred data-processing system component. The preferred embodiment of the system can be divided into three sections: a central system, a transplant center (TC) system component, and an umbilical cord blood bank (UCB bank) subsystem. The system may advantageously be used via the Internet and an intranet, and the individual components may communicate and exchange data with one another via wireless or wired connections. As demonstrated herein, UCB preparations may be supplied by donors and analyzed in an HLA laboratory. The data generated there are transmitted, for example, to the UCB bank and entered into the system and stored. Advantageously, the preparations may be physically processed and stored in the UCB bank, and the UCB preparation data obtained may advantageously be handled in the UCB bank in a laboratory management system. Information concerning selected UCB preparations may be transferred locally and incrementally into the central system, for example in the form of data sets. The preferred system advantageously provides the umbilical cord blood bank with the option of administration, inspection of communications of transplant center (TC) contacts, management of imported UCB preparations, convenient processing of requests and workflow monitoring, management of complete accounting of UCB preparation deliveries and services, and management of follow-up information. It may also be advantageous if the UCB bank communicates, for example to the clinic, orders to collect samples, via the system. It is also apparent from FIG. 3 that a physician can determine the HLA values of patients and pass them on together with further information, for example to the TC coordinator, for the search of UCB preparations. The coordinator may, for example, perform a system-based search and propose solutions and, advantageously, UCB preparations for transplantation. The patient data may be managed by the transplant center or by the hospital in a separate management system. Follow-up information may be advantageously forwarded from there to the central system after transplantation. For example, the system may provide the transplant center with the option of administration, inspection of communications of UCB bank contacts, searching for UCB preparations, convenient commissioning and monitoring of requests and workflow monitoring, management of complete accounting of UCB preparation deliveries and services, and management of follow-up information. The central system may advantageously allow secure access to data deposited in encrypted form (in a database system, for example) in order to ensure data security. The user data and settings thereof may advantageously be stored centrally so as to be available across sessions. Supervision of the central component (including set-up of new users, clinics, UCB banks) may be performed by service personnel, for example. Information uploaded by the UCB bank may be supervised in the donor management and central UCB preparation management. The UCB data may be pre-arranged according to (for example, modularly interchangeable) classification criteria (by means of a data warehouse cube, for example) in order to advantageously ensure a rapid and efficient search, even for complex multiple transplants. Advantageously, modularly different matching algorithms may be used in the matching component to generate appropriate solutions automatically or semi-automatically. All processes and interactions between the involved parties may be controlled by the workflow component. Furthermore, all transactions and services may be acquired and evaluated by the accounting component. Processed accounting information may advantageously be transferred to an accounting system for rendering of accounts, for example. The follow-up information may be supervised centrally and transferred to an external central department in which, for example, follow-up statistics may be created and returned at regular intervals.

FIG. 4 shows a high-level system overview. The illustration depicts an abstracted high-level overview of the described system with a focus on the matching support and process support for fairly large registers of patients with various indications. Various umbilical cord blood banks may place their preparations in the system and administer them via the system. Aside from the data necessary for the matching process, such as information regarding typing, quantities, and processing, the umbilical cord blood bank may also identify which preparations may be used for which indications. Transplant centers or clinics may also place comprehensive patient registers in the system and administer them there. For individual patients, data such as typing for indications may be provided. The auto-matching component of the system is able to respond to any change in the patient or preparation register, and to appropriately carry out an automatic matching process for a patient or an indication of preset search parameters, so that the system always shows a transplant center the best possible solutions for a patient, corresponding to his indications. The matching component is able to take into account medical as well as logistical aspects and, for example, to prefer a second preparation from the same clinic. The work flow management of the system then allows the largely automated handling of complex processes among all involved parties, including the UCB bank, a clinic, a transplant center, and a service provider. The system is advantageously able to increase or decrease the number of involved parties. A transplant center may initially reserve preparations, and if necessary, order further typing testing, for example, from the umbilical cord blood bank. Complex approval and confirmation processes which take place between the parties are assisted by the work flow management, thus allowing the efficiency and in particular the transplantation speed to be improved. Every year, many patients die because they cannot be provided with a suitable transplant quickly enough. If a transplant center has decided on a solution using two preparations, for example, in order to treat a DCM patient, for example, an ordering process may also be initiated via the work flow management. In this case, the system allows the transplant center to involve a processer in the order in order to prepare the preparations for the treatment, and also to involve one or more logistics service providers to initially send the preparations to the processer, and after refinement, to jointly send them to the transplant center. The refinement preferably includes the isolation and purification of certain cells. The isolation of stem cells is particularly preferred. For this purpose, typical stem cell markers may be used which present exclusively on the cell surface of stem cells. The markers allow an unambiguous identification of stem cells, and may also be used for purifying the cells. To this end, for example the stem cells are isolated from a solution using flow cytometry or specialized kits. By means of the treatment, the stem cells are advantageously separated from other cells present in the solution and isolated. The stem cells may then be expanded, optionally under cell culture conditions.

A solution refers to umbilical cord blood, for example. The processer receives the appropriately delivered preparations, and, for example, performs concentration of CD133+ cells with the aid of a selection kit. That is, cells which are positive for the cell surface molecule CD133 (“cluster of differentiation”) are isolated and concentrated. However, it may also be preferred to use other markers, in particular stem cell markers including CD133, CD34, CD7, CD44, and/or CD24 for the identification and/or concentration (refinement). The refined overall preparation may then be delivered to the transplant center by another logistics service provider. The processer and the logistics service provider may be integrated into the system via a dedicated user interface, and may offer and confirm schedules, so that the system is able to provide the transplant center with an exact delivery date in order to allow appropriate preparation for the treatment.

Via the system, the transplant center is able to check the current status of the preparations in the process at any time. In addition, after conclusion of the treatment, the workflow management offers the option for billing all involved parties and also assisting in appropriate follow-up processes in which, for example, appropriate information is asked of the users at certain points in time, and this information is stored in the system or may also be forwarded to other systems.

FIG. 5 shows a preferred use of the system. The automated system is also able to select and allocate chemical and biological therapeutic substances, and to integrate molecular or genetic analyses and diagnoses for the selection and definition of possible therapeutic approaches. By the inputting and stepwise addition of patient data from genetic, molecular, or metabolic analyses, the system allows the attending physician to recognize specific treatment corridors or exclusion criteria with regard to basically approved therapies, and to inform the patient of same prior to the treatment. The system may be assisted by imaging processes. Based on this stepwise approximation toward solutions via parallel or successive integration of diagnoses, analyses, or results and knowledge from scientific databases, the system is able for the first time to ensure complex processes for customizing treatment when handling large numbers of patients. For example, the UCB preparations and/or patients 2 collected by the system may be analyzed by genetic, molecular, or metabolic analyses (molecular diagnostics), which are clearly displayed by the system to an observer, for example an attending physician. Based on the molecular diagnostic analysis, preparations or patients may be selected which/who are suited for a specific therapy. This selection may correspondingly take place via the UCB preparations 1 or the patients 2. The donors of the UCB preparations may likewise be referred to as patients, since patients, i.e., possibly individuals with a disease, may also be donors of the UCB preparations. If, for example, a patient or a donor has leukemia, for example AML or CML, the patient or donor could be identified by the system, and the attending physician could recommend to this patient or other AML patients a possible therapy using biological, chemical, or biochemical substances. These substances include, for example, small molecules, targeted small molecules, and biological antibodies or peptides. These may involve, for example, inhibitors of certain enzymes or signal pathways whose mechanism of action is known or unknown. The physician no longer has to analyze the data of the molecular diagnostic analysis; instead, via the system he receives an overview or summary of the results, with possible therapeutic pathways or treatments being indicated by the system.

### LIST OF REFERENCE NUMERALS

1 UCB preparation

2 Patient/recipient

1. System for allocating and selecting biological cells or tissues, in particular umbilical cord blood preparations, for transplantations, therapies, and/or research purposes between at least one collection center and/or storage site and at least one clinic, transplant center, and/or research facility, which communicate with each other via wired and/or wireless connections on one or more processing units, especially computers, medical systems, storage devices, and/or special processors, and which are connected via a network comprising the multiple processing units via which data are exchanged,
wherein
the system comprises
Inputting data of umbilical cord blood preparations in a computer and storing on a storage medium,
Presetting search criteria with an option of favoring preferred storage sites, in particular the storage of the search criteria on a storage medium and/or a processing unit,
Patient search of individual and larger registers of patients with various indications, including acute myeloid leukemia (AML), dilated cardiomyopathy (DCM), diabetes mellitus, and/or ischemic stroke, and/or
Order processing and tracking, including integration of service providers comprising diagnostics service providers, logistics service providers, and/or processers, wherein the system carries out financial transactions, and in particular, the potential umbilical cord blood preparations being arranged and selected according to priority of a bank, medical and logistical factors including time and cost projections, probability of therapeutic success, HLA match, patient weight, number of nucleated cells (TNC), number of hematopoietic cells (CD34+), and number of CD133+ cells and/or other comparable cells.

2. System according to claim 1,
wherein
automated matching between the preparations and the register of patients takes place, in particular when new preparations and/or patients are introduced.

3. System according to claim 1,
wherein
in order to provide a better usable cell product, further service providers, including diagnostics service providers, logistics service providers, and processers who purify raw product of the cell, in particular using KITs, are automatically integrated into the process, which includes automated selection of the service providers as well as coordination of same by the system.

4. System according to claim 1,
wherein
the umbilical cord blood preparations are recorded using at least one of the following parameters:
Name and identification of the umbilical cord blood (UCB) storage bank,
Status of the UCB storage bank with regard to international certifications, preferably Fact,
Process reliability of the UCB bank according to classification,
Contact in the respective bank, including contact data,
Identification number of the preparation,
Approved purposes of use of the preparation,
Medical history of the mother, child, and family according to patient history form of the clinic where birth occurred,
Ethnic group of the mother, father, and/or child,
Gender of the child,
Date of initial storage of the preparation,
Details of preparation processing,
Blood group of the preparation,
HLA type of the preparation,
Cell count (TNC) of the preparation,
Cell count (CD34+) of the preparation,
Cell count (CD133+) of the preparation or other comparable cell types,
Viral status of the preparation, and/or
Allelic characteristics of the preparation.

5. System according to claim 1,
wherein
the patient search includes the determination of patient-compatible preparations according to the following classification and/or exclusion criteria:
Name and identification of the clinic or transplantation center,
Name of the coordinator and attending physician, including contact data,
Status of the clinic with regard to international certifications (Fact, for example)
Average number of UCB transplants in the inquiring clinic in the last three years,
Name of the patient, insurance number, and other accounting information,
Medical history of the patient,
Indication and therapy proposal of the attending physician,
Urgency according to defined classification,
HLA type of the patient,
Blood group of the patient,
Weight of the patient,
Ethnic group of the patient,
Gender of the patient,
Age of the patient,
Known allelic characteristics of the patient and/or data of DNA typing and/or
Initial or repeated treatment.

6. System according to claim 1,
wherein
the classification of potential umbilical cord preparations is set as follows:
$${ML}_{P rep} := \{ \begin{matrix}\begin{matrix}6 \text{:} {HLA}_{Prep } and {HLA}_{Pat} match in 6 out of 6 \\ values and blood group compatibility\end{matrix} \\ \begin{matrix}5 \text{:} {HLA}_{Prep } and {HLA}_{Pat} match in 5 out of 6 \\ values and blood group compatibility \\ \begin{matrix}4 \text{:} {HLA}_{Prep } and {HLA}_{Pat} match in 4 out of 6 \\ values and blood group compatibility \\ Preparation not included \text{:} other\end{matrix}\end{matrix}\end{matrix}$$
CF_{Prep}=cell factor defines the required number of cells per kg of patient weight at corresponding match level
$${CF}_{Prep} := \{ \begin{matrix}3 \times {10}^{7} : {ML}_{Prep} = 6 \\ 4 \times {10}^{7} : {ML}_{Prep} = 5 \\ 5 \times {10}^{7} : {ML}_{Prep} = 4\end{matrix}$$
CN_{Prep}=classification number of a preparation allowing arrangement of preparations in accordance with TNC and match level
$${CN}_{Prep} := \frac{{TNC}_{Prep}}{{CF}_{Prep}}$$
SL_{Single}=short list of preparations to be considered for single transplants
$${SL}_{Single} := \{ p ∈ Prep \vert \frac{{CN}_{p}}{{BW}_{Pat}} \geq \frac{1}{kg} ⋀ {ML}_{Prep} \geq 4 \}$$
and the standard classifications of the preparations in the short list are made according to the following criteria:
Classification 1=initial ranking according to match level, followed by classification number, followed by cell number of CDXX⁺
$$Classification 1 ( SL ) := \{ \begin{matrix} \\ p 1 ∈ SL , p 2 ∈ SL \vert \begin{matrix}either {ML}_{p 1} > {ML}_{p 2} \\ or {ML}_{p 1} = {ML}_{p 2} {CN}_{p 1} > {CN}_{p 2} \\ \begin{matrix}or {ML}_{p 1} = {ML}_{p 2} {CN}_{p 1} = \\ {CN}_{p 2} {CDXX}_{p 1} \geq {CDXX}_{p 2 }\end{matrix}\end{matrix} \\ \end{matrix} \qquad$$
Classification 2=initial ranking according to classification number, followed by match level, followed by CDXX⁺
$$Classification 2 ( SL ) := \{ Preliminary Amendment \begin{matrix} \\ p 1 ∈ SL , p 2 ∈ SL \vert \begin{matrix}either {CN}_{p 1} > {CN}_{p 2} \\ or {CN}_{p 1} = {CN}_{p 2} {ML}_{p 1} > {ML}_{p 2} \\ or {CN}_{p 1} = {CN}_{p 2} {ML}_{p 1} = \\ {ML}_{p 2} {CDXX}_{p 1}^{+} \geq {CDXX}_{p 2 }^{+} \end{matrix} \\ \end{matrix} \qquad$$
where
Prep=Umbilical cord blood preparation
Pat=Patient
HLA_{Pat}=HLA values of the patient
HLA_{Prep}=HLA values of a preparation
TNC_{Prep}=Number of nucleated cells of a preparation
BW_{Pat}=Body weight of the patient in kg
CDXX⁺_{Prep}=Number of cells which in particular include surface markers from the group “cluster of differentiation” comprising CD34 and/or CD133
ML_{Prep}=Match level according to HLA match between preparation and patient.

7. System according to claim 1,
wherein
the following classification criteria and/or exclusion criteria are used:
Priority of the storage site based on user settings, the banks being sorted in a sequential order and/or a positive/negative list and thus generating a personal ranking
For multiple preparations, the storage site of previously selected preparations in order to advantageously obtain several preparations from the same storage site or from another logistically advantageous storage site
Approved purpose of use of the preparation by the storage site
Estimated time until delivery of the preparation
Estimated cost of a preparation
Probability of success when using the preparation for the indication of the particular patient
Preparations having a CD34+ cell count above 10% of the TNC count,
Exclusion of preparations in which less than 75% of the CD34+ cells survived and/or were activated in a colony assay (CA),
CD133+ or cells with CD surface molecules
Blood group identity,
Ethnic identity,
Gender,
Age of the preparation,
Accreditation standard and/or
Ranking of the UCB bank, in particular via evaluations from all customers of this bank via personal prioritization of the user and/or ranking of the UCB bank based on the first selected preparation in a multi-preparation search, based on logistically advantageous criteria.

8. System according to claim 1,
wherein
the system is used for allocating double or multiple transplantations (multi-cord).

9. System according to claim 1,
wherein
the selection of multi-cord preparations is performed according to the following classification criteria:
ML_{P1P2}=Mutual compatibility of two preparations:
$${ML}_{P 1 P 2} := \{ \begin{matrix}\begin{matrix}6 \text{:} {HLA}_{Prep 1} and {HLA}_{Prep 2} match in 6 out of 6 \\ values and blood group compatibility\end{matrix} \\ \begin{matrix}5 \text{:} {HLA}_{Prep 1} and {HLA}_{Prep 2} match in 5 out of 6 \\ values and blood group compatibility \\ \begin{matrix}4 \text{:} {HLA}_{Prep 1} and {HLA}_{Prep 2} match in 4 out of 6 \\ values and blood group compatibility \\ Preparation not included \text{:} other\end{matrix}\end{matrix}\end{matrix}$$
BL_{Multi}=Basic list to determine the selection list for multiple preparations
$${BL}_{Multi} := \{ p ∈ Prep \vert \frac{{CN}_{p}}{{BW}_{Pat}} < \frac{1}{kg} ⋀ {ML}_{Prep} \geq 4 \}$$
SL_{Multi}=Short list of preparations to be included in multiple transplants
$${SL}_{Multi} := \{ p 1 ∈ {BL}_{Multi} , p 2 ∈ {BL}_{Multi} \vert {ML}_{p 1 p 2} \geq 4 ⋀ \frac{{CN}_{p 1} + {CN}_{p 2}}{{BW}_{Pat}} \geq 1 \}$$

10. System according to claim 1,
wherein
the search criteria of the system are adapted to the entered criteria and/or parameters.

11. System according to claim 1,
wherein
the system uses a matrix to display the results, and displays the results visually.

12. A method for selecting a cell preparation that is suitable for the allogeneic transplantation comprising
inputting data of umbilical cord blood preparations in a computer and storing on a storage medium,
presetting search criteria with an option of favoring preferred storage sites, in particular storage of search criteria on a storage medium and/or a processing unit,
conducting a patient search of individual and larger registers of patients with various indications, including acute myeloid leukemia (AML), dilated cardiomyopathy (DCM), diabetes mellitus, and/or ischemic stroke, and/or
order processing and tracking, including an integration of service providers comprising diagnostics service providers, logistics service providers, and/or processers, wherein financial transactions are carried out by a system adapted to carry out the method of selecting the cell preparation, and
arranging and selecting potential umbilical cord blood preparations according to priority of a bank, medical and logistical factors including time and cost projections, probability of therapeutic success, HLA match, patient weight, number of nucleated cells (TNC), number of hematopoietic cells (CD34+), and number of CD133+ cells and/or other comparable cells.

13. The method of claim 12 further comprising coordinating between a clinic, transplant center, attending physician, storage sites, logistics service providers, and processers of the preparations.

14. The method of claim 12, further comprising automatically selecting a single-cord or multi-cord transplant.

15. The method of claim 12, wherein statistics relating to expected costs and required time are used to assess a status of a determination of classification criteria.
